(19) United States
(12) Patent Application Publication
(10) Pub. No.: US 2003/0029063 A1
(43) Pub. Date: Feb. 13, 2003

(54) Product label with ID chip

(75) Inventors: Mutsuharu Takesada, Yokohama-shi (JP); Norikazu Yamagishi, Yokohama-shi (JP); Takaaki Habara, Yokohama-shi (JP)

Correspondence Address: Christopher J. Fildes, Fildes & Outland, P.C., Suite 2, 20916 Mack Avenue, Grosse Pointe Woods, MI, 48236, US

(73) Assignee: Hitachi Electronic Service Co., Ltd.

(21) Appl. No.: 10/199,761

(22) Filed: Jul. 18, 2002

(30) Foreign Application Priority Data
Aug. 9, 2001 (JP) 2001-242753

(51) Int. Cl. G09F 3/10

(52) U.S. Cl. 40/299.01; 40/638

(57) ABSTRACT

A product label 1 with an ID chip comprises a sheet-like label body 10 to be adhered to a product, and a particle-like micro ID chip 2 embedded to the label body 10 that records as product information the name of the product, the manufacturer, the price, the manufactured date, or the expiration date. Said label body 10 having the ID chip 2 embedded thereto is adhered to a product. The ID chip 2 embedded to the label body 10 will not break even when the label is bent. Due to its large memory capacity, the ID chip 2 is capable of storing a greater amount of product information.

### BACKGROUND OF THE INVENTION

The present invention relates to a product label with an ID chip, wherein an ID chip recording various product data is embedded to the product label.

As shown in FIG. 4, a prior art product label 5 with a barcode comprises a sheet-like label body 50 that can be adhered to a product, an indication 52 printed on the front surface 51 of the label body 50 that indicates the name of the product, the manufacturer, the manufactured date, the expiration date, and the price of the product, and a barcode 53 printed on the same surface that includes codes representing the name of the product, the manufacturer of the product and the like.

Further, Japanese Patent Laid-Open Publication No. 2001-5931 discloses a barcode seal having an RFID function, the barcode seal comprising a bar code printed on the surface of a seal, and a non-contact ID tag mounted to the rear surface of the seal having an adhesive layer that includes a read-only fixed ID unit and a variable ID unit consisting of plural memory cells capable of varying its ID code in response to a command received from the outside.

According to the prior-art product label 5 with a barcode as shown in FIG. 4, however, a number having only up to 10 digits could be recorded to the barcode 53 being printed on the surface 51 of the label body 50. Even further, if the label body 50 having the barcode 53 printed on its surface is bent or contaminated, there is fear that the information on the barcode 53 may no longer be read by the barcode reader or barcode scanner. Moreover, the label body 50 must be sufficiently large in order to provide a special space on the surface of the label to which the barcode 53 is printed.

On the other hand, in the bar code seal having an RFID function disclosed in Japanese Patent Laid-Open No. 2001-5931, there is fear that the IC chip embedded to the barcode seal may break when the seal is bent, so in order to prevent the IC chip from breaking, the chip must be embedded to the adhesive layer with a protective coating composed of nonconductive material.

### SUMMARY OF THE INVENTION

The object of the present invention is therefore to solve the above-mentioned problems of the prior art, by providing a product label with an ID (identification) chip comprising a particle-shaped micro ID chip embedded to a label body, the ID chip being capable of recording various product information. The ID chip will not break even when the product label is bent, and it is capable of recording more product information than the prior art barcode or IC chip, so the product label having the ID chip according to the present invention contributes to the improvement of product management utilizing the information recorded in the ID chip.

According to the product label with an ID chip comprising a sheet-type label body that can be adhered to a product, the label body includes a particle-like micro ID chip embedded thereto, the chip recording as product information the name of the product, the manufacturer, the price, the manufactured date, or the expiration date.

According further to the present product label with an ID chip, the position to which the ID chip is embedded is the center area, the periphery, or any of the corners of the label body.

According further to the present product label with an ID chip, an indication is provided to the label body showing that an ID chip is embedded thereto.

According even further to the present product label with an ID chip, an indication showing the position where the ID chip is embedded is provided to the label body.

According to the present product label with an ID chip, the product information recorded in the ID chip is optional information determined corresponding to the application of the label.

According to the present product label with an ID chip, the label body is provided with an adhesive surface either to one side of or both sides thereof, enabling the label body to be adhered to the product.

According even further to the present product label with an ID chip, the label body is adhered to a wrapper or a packaging material of the product.

### BRIEF DESCRIPTION OF THE DRAWINGS

FIG. 1 is a plan view showing the product label with an ID chip according to an embodiment of the present invention;

FIG. 2 is a bottom view of FIG. 1;

FIG. 3 is an enlarged cross-sectional view showing the main part of the product label with an ID chip laminated on a release coated paper; and

FIG. 4 is a plan view of the prior art product label with a barcode.

### DETAILED DESCRIPTION OF THE PREFERRED EMBODIMENT

The preferred embodiment of the present invention will now be explained in detail with reference to the accompanying drawings.

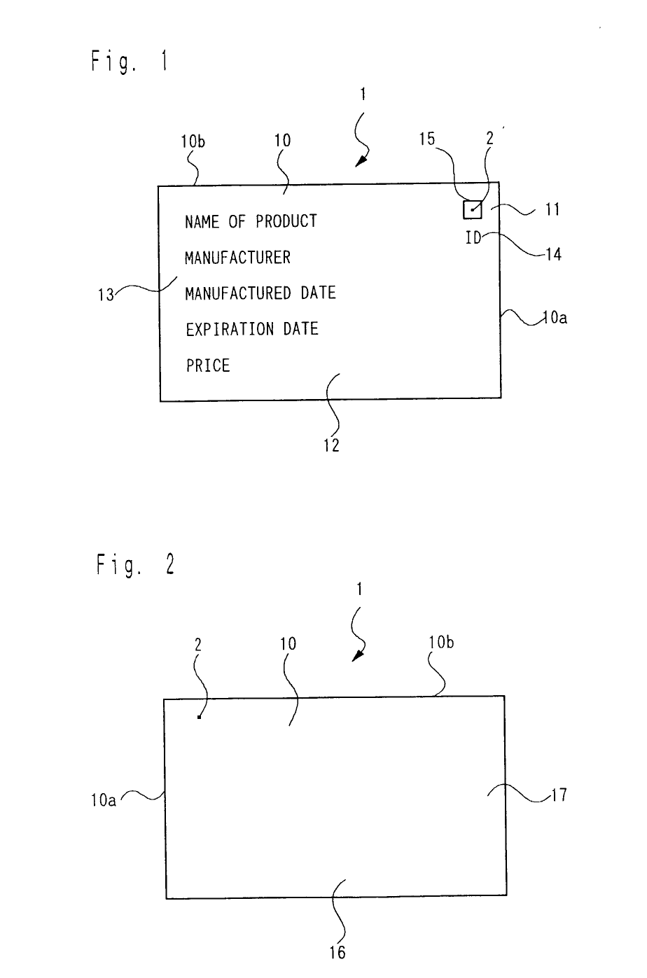

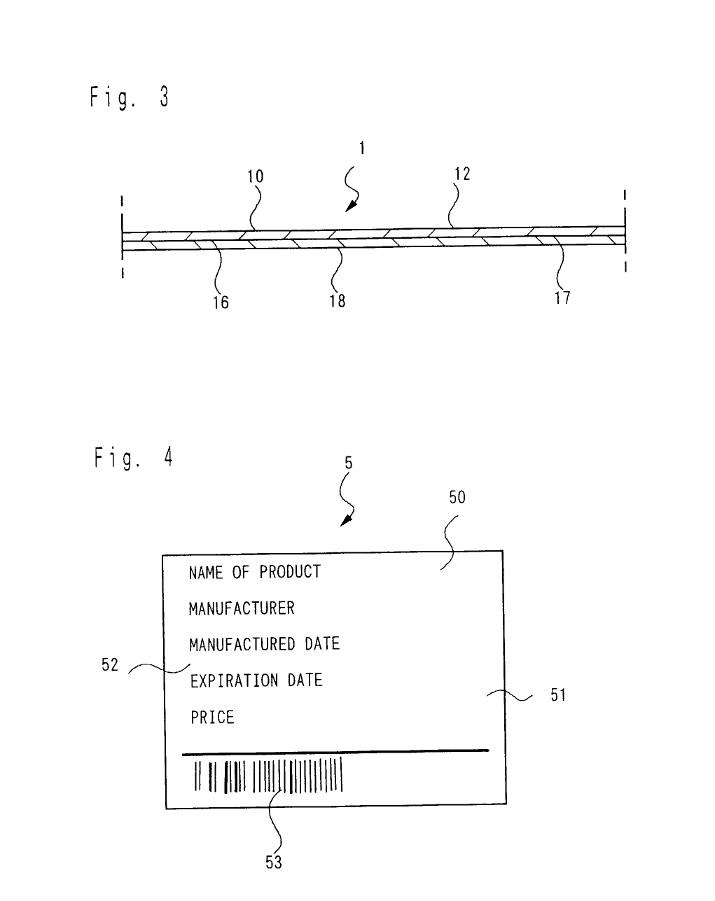

FIG. 1 is a plan view showing the product label with an ID chip according to an embodiment of the present invention, FIG. 2 is a bottom view of FIG. 1, and FIG. 3 is an enlarged cross-sectional view showing the main portion of the product label with an ID chip laminated on a release coated paper.

As shown in FIG. 1, the product label 1 with an ID chip according to the present invention comprises a sheet-type label body 10 that can be adhered to a product, and a particle-type micro ID chip 2 embedded to the corner portion 11 of the label body 10 at the crossing of a side rim 10a and an upper rim 10b. The micro ID chip 2 records the information of the product, such as the name of the product, the manufacturer, the price, the manufactured date, or the expiration date.

As shown in FIG. 1, an indication 13 showing the name of the product, the manufacturer, the manufactured date, the expiration date, and the price is printed on the front surface 12 of the label body 10 of the product label 1 with an ID chip.

The content of the data recorded to the ID chip 2 embedded to the label body 10 of the product label 1 relates to the product information, which are the name of the product, the name of the manufacturer, the produced date, the expiration date, and the price.

As shown in FIG. 1, an indication (message) 14 informing that the ID chip 2 is embedded to the label is printed on the front surface 12 of the label body 10 of the product label 1 with an ID chip.

As shown further in FIG. 1, a mark 15 that shows the area where the ID chip 2 is embedded is provided by print on the surface 12 of the label body 10 of the product label 1.

An adhesive surface 17 having an adhesive applied thereto as shown in FIG. 2 is formed to the back surface 16 of the label body 10 of the product label 1 with an ID chip.

A release coated paper 18 is laminated on the adhesive surface 17 of the label body 10 as shown in FIG. 3.

In the product label 1 according to the present invention, the position to which the ID chip 2 is to be embedded is selected from the center, the periphery or the four corners of the label body 10.

The present product label 1 with the ID chip is provided with an indication notifying that an ID chip is embedded thereto on the surface of the label body 10.

The present product label 1 is also provided with an indication showing the position of the ID chip on the surface of the label body 10.

The product information recorded in the ID chip 2 can be any optional information corresponding to the need and use of the product label 1.

The present product label 1 with an ID chip has an adhesive surface either on one or both of its surfaces, enabling the label body 10 to be adhered onto any desired product.

When bonding the product label 1 with an ID chip to the product, the label body 10 is adhered either to the wrapper or the packaging material of the product.

The ID chip 2 embedded to the label body 10 of the product label 1 comprises a particle-like micro IC (integrated circuit) chip, and this micro IC chip is capable of storing a number having a maximum of 38 digits.

The size of the ID chip 2 is 0.4 mm square with a thickness of 0.06 mm, and the chip 2 will not be damaged even when the label body 10 to which it is embedded is bent. The chip 2 is equipped with a 128-bit ROM (Read Only Memory).

The method for using the product label 1 with an ID chip according to the present embodiment will now be explained in detail.

First, the release coated paper 18 is removed from the adhesive surface 17 of the label body 10 of the product label 1 with an ID chip, and the label body 10 is adhered to the product.

The product information recorded to the ID chip 2 embedded to the label body 10 of the product label can be read via radio transmission using a dedicated reader.

By adhering the product label 1 with an ID chip to the wrapper for wrapping the product or the packaging material for packing the product, logistics and product management of the wrapped or packaged product can be performed easily using the product label 1 with an ID chip.

The material of the label body 10 of the product label 1 with an ID chip can be paper, paperboard, synthetic paper, synthetic resin sheet, synthetic resin film, or the like.

Further, according to the above-explained embodiment the ID chip is embedded in the label body, but the ID chip of the present invention can also be embedded to a tag provided to each product.

According to the product label with an ID chip of the present invention, a particle-like micro ID chip is embedded in a label body, the ID chip being capable of recording various product information and will not break even when the label body to which the ID chip is embedded is bent. Further, the memory capacity of the ID chip is greater compared to the barcode of the prior-art product label, which advantageously enables more product information to be recorded to the ID chip of the product label. The product label with an ID chip according to the invention can be manufactured easily by merely embedding a micro ID chip to the label body, so mass production of the product label is enabled at a low cost. Since the ID chip is smaller than a grain of rice, there is no need to provide a special space on the label surface for the ID chip, so the label body can be minimized. Moreover, the product information recorded in the ID chip can be read out easily using a dedicated reader, so product management of the product to which the product label is adhered can be performed easily.

According to the product label with an ID chip of the present invention, the position to which the ID chip is embedded can be selected from the center, the periphery or the corners of the product label, so in other words the ID chip can be embedded to any desired position on the label body.

According even further to the product label with an ID chip of the invention, the label body is provided with an indication notifying that an ID chip is embedded thereto, so the user/consumer can confirm visually that the product label is provided with an ID chip.

Further, an indication showing the position to which the ID chip is embedded is also provided to the surface of the label body, so the user/consumer can easily confirm visually the position of the ID chip.

The ID chip embedded to the present product label can record any optional product information according to the need and use of the product.

The adhesive surface provided to either one of or both sides of the label body enables the label body to be adhered to the product easily.

Moreover, according to the present invention, the label body having an ID chip embedded thereto is adhered to the wrapper or the packaging material of the product, enabling easy logistics and product control of the wrapped or packaged product with the ID chip.

What is claimed is:

1. A product label with an ID chip comprising a sheet-like label body that can be adhered to a product; wherein
said label body includes a particle-shaped micro ID chip embedded thereto, said chip recording as product information any of the name of the product, the manufacturer, the price, the manufactured date, or the expiration date.

2. A product label with an ID chip according to claim 1, wherein the position to which the ID chip is embedded is the center area, the periphery, or any of the corners of said label body.

3. A product label with an ID chip according to claim 1, wherein an indication showing that an ID chip is embedded thereto is provided to the label body.

4. A product label with an ID chip according to claim 2, wherein an indication showing that an ID chip is embedded thereto is provided to the label body.

5. A product label with an ID chip according to claim 1, wherein an indication showing the position where said ID chip is embedded is provided to the label body.

6. A product label with an ID chip according to claim 1, wherein an indication showing the position where said ID chip is embedded is provided to the label body.

7. A product label with an ID chip according to claim 2, wherein an indication showing the position where said ID chip is embedded is provided to the label body.

8. A product label with an ID chip according to claim 3, wherein an indication showing the position where said ID chip is embedded is provided to the label body.

9. A product label with an ID chip according to claim 1, wherein said product information recorded in said ID chip is an optional information determined corresponding to the application of said product label.

10. A product label with an ID chip according to claim 2, wherein said product information recorded in said ID chip is an optional information determined corresponding to the application of said product label.

11. A product label with an ID chip according to claim 3, wherein said product information recorded in said ID chip is an optional information determined corresponding to the application of said product label.

12. A product label with an ID chip according to claim 5, wherein said product information recorded in said ID chip is an optional information determined corresponding to the application of said product label.

13. A product label with an ID chip according to claim 1, wherein said label body is provided with an adhesive surface either to one side of or both sides thereof, enabling the label body to be adhered to the product.

14. A product label with an ID chip according to claim 1, wherein said label body is adhered to a wrapper or a packaging material of said product.
